(19) United States
(12) Patent Application Publication
(10) Pub. No.: US 2022/0228856 A1
(43) Pub. Date: Jul. 21, 2022

(54) IMPROVED 3D SENSING

(71) Applicant: CAMBRIDGE MECHATRONICS LIMITED, Cambridge, Cambridgeshire (GB)

(72) Inventor: Andrew Benjamin Simpson Brown, Cambridge (GB)

(21) Appl. No.: 17/610,103

(22) PCT Filed: May 21, 2020
(86) PCT No.: PCT/GB2020/051248

§ 371 Date: Nov. 9, 2021

(30) Foreign Application Priority Data
May 21, 2019 (GB) 1907188.5

(51) Int. Cl. G01B 11/25; G01B 11/22

(52) U.S. Cl. CPC G01B 11/2513; G01B 11/22

(57) ABSTRACT

An apparatus (100) for use in a device for generating a three-dimensional (3D) representation of a scene. The apparatus (100) comprises an emitter module (104) having an emitter for emitting a plurality of waves in a predetermined pattern, wherein the pattern has a primary axis. The apparatus (100) further comprises a static portion and a movable portion (116). The movable portion (116) is configured to allow the emitter module (104) to emit the predetermined pattern in a plurality of different arrangements depending on the position and/or orientation of the movable portion (116). A mechanical element (150) of the apparatus (100) constrains movement of the movable portion (116) so as to provide a predictable orientation of the primary axis relative to the static portion in one or more of the different arrangements.

The present techniques generally relate to apparatus and methods for generating a three-dimensional (3D) representation of a scene (also known as 3D sensing) and in particular to techniques for improving the accuracy of the three-dimensional representation.

A number of different methods are being developed and used for 3D sensing. Many of these methods involve so-called “depth maps” which aim to establish distance information of objects in a scene. Generally speaking, the devices used to generate 3D representations/perform 3D sensing may incorporate an emitter of waves (e.g.

electromagnetic or sound), and a corresponding detector or sensor for detecting the reflected waves.

For the purpose of 3D sensing or depth mapping, it may be useful to emit patterned light or structured light, typically infrared (IR) light. Structured radiation may be, for example, a pattern formed of a plurality of dots or points of light. When a light pattern is emitted, a receiver may detect distortions of the projected light pattern which are caused when the light pattern reflects from objects in a scene being imaged. The distortions of the original light pattern may be used to generate a 3D representation of the scene.

Thus, the devices which may be used to generate a 3D representation of a scene may incorporate a structured light projector (i.e. a component that projects patterned light, typically an array of dots).

Examples of techniques which may be used to generate a 3D representation of a scene using a structured light projector are described in the applicant's co-pending application PCT/GB2019/050965. In these techniques, elements of the apparatus for generating a 3D representation of a scene may be movable relative to each other to improve the accuracy of the 3D representation generated.

Other examples of techniques which may be used to generate a 3D representation of a scene using time of flight methods are described in the applicant's co-pending application GB1906885.7. In these techniques, illumination having a spatially-nonuniform intensity over the field of view of the sensor (e.g. a pattern) is moved across at least part of the field of view of the sensor.

Generally, in order for a structured light depth sensor to correctly calculate the depth, the angle of emission of the projected dots in (i.e. when projected onto) a particular plane must be accurately known. In particular, this plane may correspond to the plane containing both the optical axis of the detector (e.g. a camera) and the emitter. Errors in this angle will cause the depth calculation to infer that the observed object is closer or further from the detector than is actually the case. When an elements of the apparatus are movable relative to each other, (e.g. when an actuator is used to move the position of the dots in a structured light arrangement), this movement (and/or the operation of the actuator) may result in additional errors to this angle.

An object of the present techniques is to increase the accuracy of methods and devices for producing 3D representations, particularly, but not exclusively, apparatuses which use a structured light approach.

At their broadest, some approaches of the present techniques provide ways of increasing the predictability of the patterns emitted from devices for producing 3D representations which have movable elements in the device.

According to a first aspect, there is provided a method for use in generating a three-dimensional representation of a scene, the method comprising:
emitting a plurality of emitted waves in a predetermined pattern, the pattern having a primary axis;
moving a movable portion relative to a static portion of an emitter module so as to emit said predetermined pattern in a plurality of different arrangements depending on the position and/or orientation of the movable portion;
wherein the movement of the movable portion is constrained by a mechanical element so as to provide a predictable orientation of the primary axis relative to the static portion in one or more of the different arrangements.

The moving may comprise moving the movable portion to one or more positions and/or orientations relative to the static portion, each of those positions and/or orientations causing the emitter module to emit said predetermined pattern in a different one of said plurality of arrangements.

The moving may comprise urging the movable portion against the mechanical element in each of said one or more positions and/or orientations such that the position and/or orientation of the movable portion is predictable.

The mechanical element may constrain movement of the movable portion in each of the one or more positions in two mutually orthogonal directions and/or about two mutually orthogonal axes.

The moving may be performed by controlling the direction rather than the magnitude of displacement of the movable portion.

As will be appreciated, where, for example, the mechanical element constrains movement of the movable portion in two mutually orthogonal directions, the movable portion may be urged against the mechanical element and into a said position (e.g. a corner position) by movement in a range of directions.

The moving may be performed by controlling an SMA actuator.

The moving may be performed without feedback, i.e. with an open-loop control system. As will be appreciated, such a control system can have certain advantages in certain circumstances.

The method may comprise:
moving the movable part to a first position and/or orientation in which a first arrangement of said predetermined pattern is emitted and a second position and/or orientation in which a second arrangement of said predetermined pattern is emitted, wherein the movable portion is constrained by the mechanical element in the first position and/or orientation and is unconstrained by the mechanical element in the second position and/or orientation;
receiving, for each of the first and second arrangements of said predetermined pattern, a reflected wave arrangement including reflected waves which are reflections from one or more objects in a scene; and processing the reflected waves received at the receiver and correcting for the effects of variations in the reflected wave arrangements caused by errors in the positioning of the movable element in the second position and/or orientation based on the reflected waves received for the first position.

According to a second aspect, there is provided apparatus for use in a device for generating a three-dimensional representation of a scene, the apparatus comprising:
an emitter module having:
   an emitter for emitting a plurality of emitted waves in a predetermined pattern, the pattern having a primary axis;
a static portion; and
a movable portion configured to allow the emitter module to emit said predetermined pattern in a plurality of different arrangements depending on the position and/or orientation of the movable portion; and
a mechanical element to constrain the movement of the movable portion so as to provide a predictable orientation of the primary axis relative to the static portion in one or more of the different arrangements.

According to a third aspect, there is provided apparatus for generating a three-dimensional representation of a scene, the apparatus comprising:
an emitter module for emitting a plurality of emitted waves in a predetermined pattern;
a movable portion configured to allow the emitter module to emit said predetermined pattern in a plurality of different arrangements depending on the position and/or orientation of the movable portion;
a receiver for receiving a plurality of reflected wave arrangements for each of the different arrangements of the predetermined pattern, the reflected wave arrangements including reflected waves which are reflections from one or more objects in the scene, and a processor for processing the reflected waves received at the receiver which is configured to correct for the effects of variations in the reflected wave arrangements caused by errors in the positioning of the movable portion based on a relationship between the reflected waves received in two or more of the plurality of reflected wave arrangements.

Further, optional features of the second and third aspects are specified in the dependent claims.

According to a fourth aspect, there method for use in generating a three-dimensional representation of a scene, the method comprising:
emitting a plurality of emitted waves in a predetermined pattern, the pattern;
moving a movable portion relative to a static portion of an emitter module so as to emit said predetermined pattern in a plurality of different arrangements depending on the position and/or orientation of the movable portion;
receiving a plurality of reflected wave arrangements for each of the different arrangements of the predetermined pattern, the reflected wave arrangements including reflected waves which are reflections from one or more objects in the scene, and
processing the reflected waves received at the receiver and correcting for the effects of variations in the reflected wave arrangements caused by errors in the positioning of the movable portion based on a relationship between the reflected waves received in two or more of the plurality of reflected wave arrangements.

There may also be provided a non-transitory data carrier carrying processor control code to implement the methods.

Any one of more of the aspects (e.g. the second and third aspects) may be combined. In particular, one or more features or further features of an aspect may be combined with those of another aspects.

As will be appreciated, the abovedescribed actuation-related aspects may have applications other than in generating a three-dimensional representation of a scene. Hence, for example, according to a fifth aspect, there is provided a method for use in controlling an actuator assembly, the method comprising:

moving a movable portion relative to a static portion to a plurality of arrangements, each arrangement corresponding to a different position and/or orientation of the movable part;

wherein the movement of the movable portion is constrained by a mechanical element so as to provide a predictable position and/or orientation of the movable portion in one or more of the different arrangements. As will be appreciated, this fifth aspect may further comprise one or more of the features of the other aspects specified herein.

Embodiments of the present techniques will now be described by way of example with reference to the accompanying drawings in which:

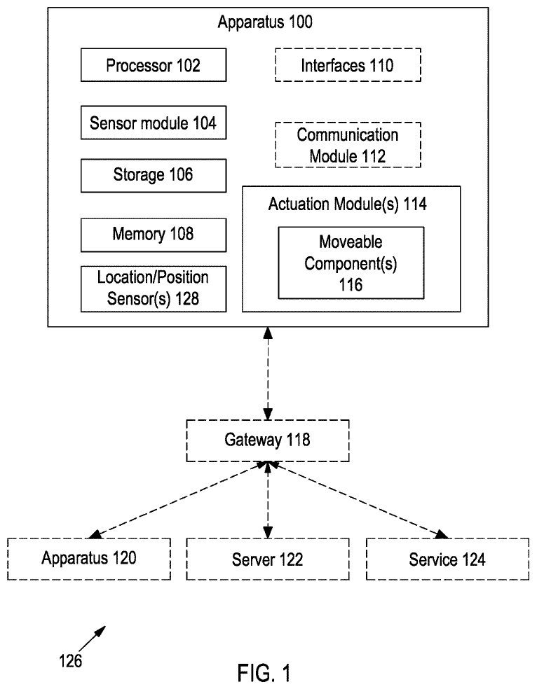

FIG. 1 shows a schematic diagram of an apparatus or system for generating a three-dimensional representation of a scene (or for 3D sensing);

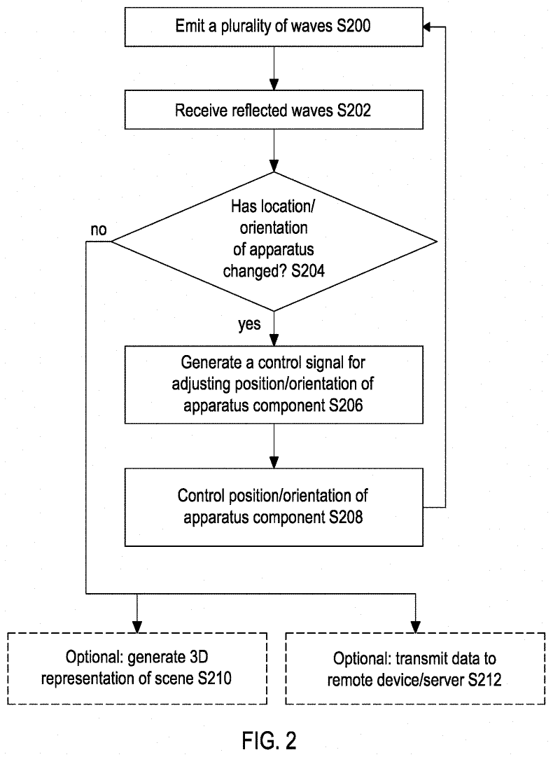

FIG. 2 shows a flowchart of example steps for generating a three-dimensional representation of a scene;

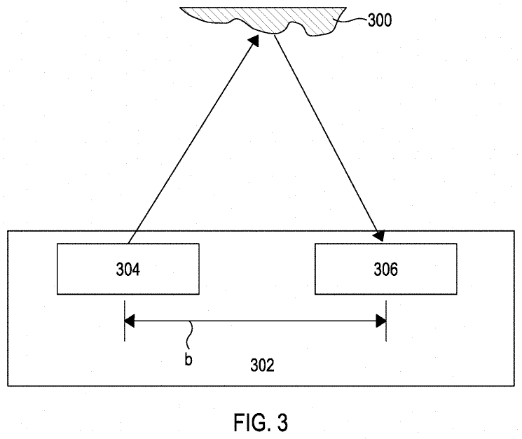

FIG. 3 is a schematic diagram showing an apparatus or system for 3D sensing;

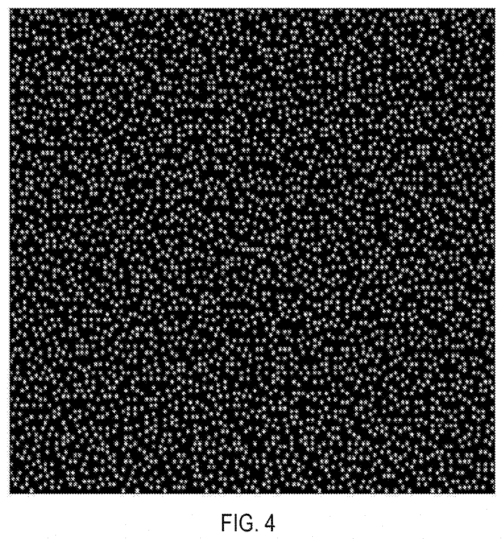

FIG. 4 shows an exemplary pattern of light that may be used for 3D sensing;

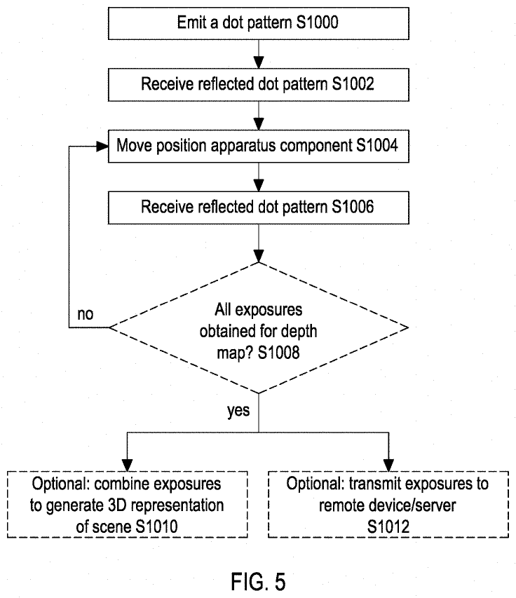

FIG. 5 is a flowchart of example steps for generating a 3D representation of a scene;

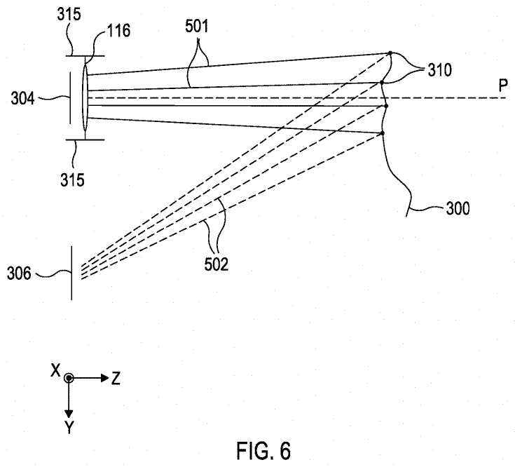

FIG. 6 is a schematic diagram of parts of an apparatus or system for 3D sensing;

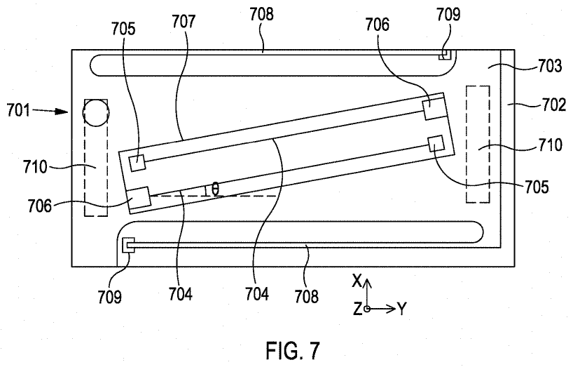

FIG. 7 shows an example of an SMA actuator including a bearing which may be used to constrain the movement of a movable element;

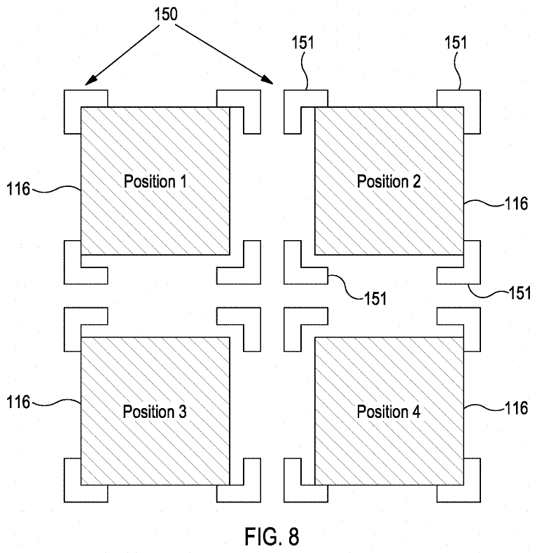

FIG. 8 is a schematic diagram of how a movable element may interact with a plurality of reference surfaces to define a plurality of reference positions; and

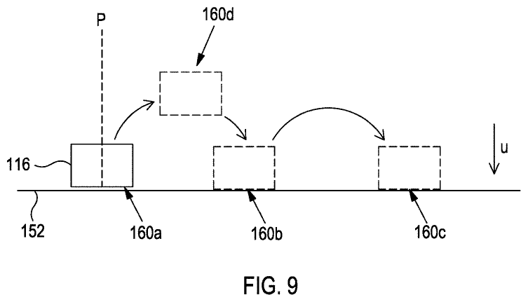

FIG. 9 is a schematic diagram showing how a movable element may interact with a single reference surface to define a plurality of reference positions.

The present techniques may provide a way to emit patterned light/structure radiation in order to generate a 3D representation of a scene, by purposefully moving components used to emit the patterned light and/or receive the distorted pattern. For example, if an apparatus comprises two light sources (e.g. two lasers), actuators may be used to move one or both of the light sources to cause an interference pattern, or if an apparatus comprises a single light source and a beam splitter, an actuator may be used to move one or both of the light source and beam splitter to create an interference pattern. Interference of the light from the two sources may give rise to a pattern of regular, equidistant lines, which can be used for 3D sensing. Using actuators to move the light sources (i.e. change their relative position and/or orientation) may produce an interference pattern having different sizes. In another example, an apparatus may project a light pattern, e.g. by passing light through a spatial light modulator, a transmissive liquid crystal, or through a patterned plate (e.g. a plate comprising a specific pattern of holes through which light may pass), a grid, grating or diffraction grating.

Existing 3D sensing systems may suffer from a number of drawbacks. For example, the strength of IR illumination may be quite weak in comparison to ambient illumination (especially in direct sunlight), meaning that multiple measurements may need to be taken to improve the accuracy of the measurement (and therefore, the accuracy of the 3D representation). Structured light (dot pattern) projectors may need to limit the resolution contained within the light pattern so that the distortion of the emitted light pattern may be interpreted easily and without ambiguity. For structured light, there is also a trade-off between the quality of depth information and the distance between the emitter and receiver in the device—wider spacing tends to give a better depth map but is more difficult to package, especially in a mobile device.

Meanwhile, in order to improve the quality of the deduced depth map, alignment of the light emitter to the detector is considered exceptionally important. Hence, anything that interferes with the baseline distance between the emitter and the detector may be disadvantageous.

FIG. 1 shows a schematic diagram of an apparatus 100 and system 126 for generating a three-dimensional representation of a scene (or for 3D sensing). The apparatus 100 may be used to generate the 3D representation (i.e. perform 3D sensing), or may be used to collect data useable by another device or service to generate the 3D representation. Apparatus 100 may be any device suitable for collecting data for the generation of a 3D representation of a scene/ 3D sensing. For example, apparatus 100 may be a smartphone, a mobile computing device, a laptop, a tablet computing device, a security system (e.g. a security system to enable access to a user device, an airport security system, a bank or internet banking security system, etc.), a gaming system, an augmented reality system, an augmented reality device, a wearable device, a drone (such as those used for aerial surveying or mapping), a vehicle (e.g. a car comprising an advanced driver-assistance system), or an autonomous vehicle (e.g. a driverless car). It will be understood that this is a non-limiting list of example devices. In embodiments, apparatus 100 may perform both data collection and 3D representation generation. For example, a security system and an autonomous vehicle may have the capabilities (e.g. memory, processing power, processing speed, etc.) to perform the 3D representation generation internally. This may be useful if the 3D representation is to be used by the apparatus 100 itself. For example, a security system may use a 3D representation of a scene to perform facial recognition and therefore, may need to collect data and process it to generate the 3D representation (in this case of someone's face).

Additionally or alternatively, apparatus 100 may perform data collection and may transmit the collected data to a further apparatus 120, a remote server 122 or a service 124, to enable the 3D representation generation. This may be useful if the apparatus 100 does not need to use the 3D representation (either immediately or at all). For example, a drone performing aerial surveying or mapping may not need to use a 3D representation of the area it has surveyed/mapped and therefore, may simply transmit the collected data. Apparatus 120, server 122 and/or service 124 may use the data received from the apparatus 100 to generate the 3D representation. Apparatus 100 may transmit the raw collected data (either in real-time as it is being collected, or after the collection has been completed), and/or may transmit a processed version of the collected data. Apparatus 100 may transmit the raw collected data in real-time if the data is required quickly to enable a 3D representation to be generated as soon as possible. This may depend on the speed and bandwidth of the communication channel used to transmit the data. Apparatus 100 may transmit the raw collected data in real-time if the memory capacity of the apparatus 100 is limited.

One-way or two-way communication between apparatus 100 and apparatus 120, remote server 122 or service 124 may be enabled via a gateway 118. Gateway 118 may be able to route data between networks that use different communication protocols. One-way communication may be used if apparatus 100 simply collects data on the behalf of another device, remote server or service, and may not need to use the 3D representation itself. Two-way communication may be used if apparatus 100 transmits collected data to be processed and the 3D representation to be generated elsewhere, but may wish to use the 3D representation itself. This may be the case if the apparatus 100 does not have the capacity (e.g. processing and/or memory capacity) to process the data and generate the 3D representation itself.

Whether or not apparatus 100 generates the 3D representation itself, or is part of a larger system 126 to generate a 3D representation, apparatus 100 may comprise a sensor module 104 and at least one actuation module 114. The sensor module 104 may comprise an emitter for emitting a plurality of waves (e.g. electromagnetic waves or sound waves), and a receiver for receiving reflected waves that are reflected by one or more objects in a scene. (It will be understood that the term ‘object’ is used generally to mean a ‘feature’ of a scene. For example, if the scene being imaged is a human face, the objects may be the different features of the human face, e.g. nose, eyes, forehead, chin, cheekbones, etc., whereas if the scene being imaged is a town or city, the objects may be trees, cars, buildings, roads, rivers, electricity pylons, etc.). Where the emitter of the sensor module 104 emits electromagnetic waves, the emitter may be or may comprise a suitable source of electromagnetic radiation, such as a laser. Where the emitter of the sensor module 104 emits sound waves, the emitter may be or may comprise a suitable source of sound waves, such as a sound generator capable of emitting sound of particular frequencies. It will be understood that the receiver of the sensor module 104 corresponds to the emitter of the sensor module. For example, if the emitter is or comprises a laser, the receiver is or comprises a light detector.

The or each actuation module 114 of apparatus 100 comprises at least one shape memory alloy (SMA) actuator wire. The or each actuation module 114 of apparatus 100 may be arranged to control the position and/or orientation of one or more components of the apparatus. Thus, in embodiments the apparatus 100 may comprise dedicated actuation modules 114 that may each move one component. Alternatively, the apparatus 100 may comprise one or more actuation modules 114 that may each be able to move one or more components. Preferably, the or each actuation module 114 is used to control the position and/or orientation of at least one moveable component 116 that is used to obtain and collect data used for generating a 3D representation. For example, the actuation module 114 may be arranged to change the position and/or orientation of an optical component used to direct the waves to the scene being imaged. SMA actuator wires can be precisely controlled and have the advantage of compactness, efficiency and accuracy. Example actuation modules (or actuators) that use SMA actuator wires for controlling the position/orientation of components may be found in International Publication Nos. WO2007/113478, WO2013/175197, WO2014083318, and WO2011/104518, for example.

The apparatus 100 may comprise at least one processor 102 that is coupled to the actuation module(s) 114. In embodiments, apparatus 100 may comprise a single actuation module 114 configured to change the position and/or orientation of one or more moveable components 116. In this case, a single processor 102 may be used to control the actuation module 114. In embodiments, apparatus 100 may comprise more than one actuation module 114. For example, a separate actuation module 114 may be used to control the position/orientation of each moveable component 116. In this case, a single processor 102 may be used to control each actuation module 114, or separate processors 102 may be used to individually control each actuation module 114. In embodiments, the or each processor 102 may be dedicated processor(s) for controlling the actuation module(s) 114. In embodiments, the or each processor 102 may be used to perform other functions of the apparatus 100. The or each processor 102 may comprise processing logic to process data (e.g. the reflected waves received by the receiver of the sensor module 104 ). The processor(s) 102 may be a microcontroller or microprocessor. The processor(s) 102 may be coupled to at least one memory 108. Memory 108 may comprise working memory, and program memory storing computer program code to implement some or all of the process described herein to generate a 3D representation of a scene. The program memory of memory 108 may be used for buffering data while executing computer program code.

Processor(s) 102 may be configured to receive information relating to the change in the position/location and/or orientation of the apparatus 100 during use of the apparatus 100. In particular, the location and/or orientation of the apparatus 100 relative to any object(s) being imaged may change during a depth measurement/3D sensing operation. For example, if the apparatus 100 is a handheld device (e.g. a smartphone), when the apparatus 100 is being used to generate a 3D representation of a scene, the location and/or orientation of the apparatus 100 may change if the hand of a user holding the apparatus 100 shakes.

Apparatus 100 may comprise communication module 112. Data transmitted and/or received by apparatus 100 may be received by/transmitted by communication module 112. The communication module 112 may be, for example, configured to transmit data collected by sensor module 104 to the further apparatus 120, server 122 and/or service 124.

Apparatus 100 may comprise interfaces 110, such as a conventional computer screen/display screen, keyboard, mouse and/or other interfaces such as a network interface and software interfaces. Interfaces 110 may comprise a user interface such as a graphical user interface (GUI), touch screen, microphone, voice/speech recognition interface, physical or virtual buttons. The interfaces 100 may be configured to display the generated 3D representation of a scene, for example.

Apparatus 100 may comprise storage 106 to store, for example, any data collected by the sensor module 104, to store any data that may be used to help generate a 3D representation of a scene, or to store the 3D representation itself, for example.

As mentioned above, the actuation module(s) 114 may be arranged to move any moveable component(s) 116 of apparatus 100. The actuation module 114 may control the position and/or orientation of the emitter. The actuation module 114 may control the position and/or orientation of the receiver. The actuation module(s) 114 may be arranged to move any moveable component(s) 116 to compensate for movements of the apparatus 100 during the data capture process (i.e. the process of emitting waves and receiving reflected waves), for the purpose of compensating for a user's hand shaking, for example. Additionally or alternatively, the actuation module(s) 114 may be arranged to move any moveable component(s) 116 to create and emit structured radiation. As mentioned above, structured radiation may be, for example, a pattern formed of a plurality of dots or points of light. When a light pattern is emitted, a receiver may detect distortions of the projected light pattern which are caused when the light pattern reflects from objects in a scene being imaged. Thus, if apparatus 100 comprises two light sources (e.g. two lasers), the actuation module(s) 114 may be used to move one or both of the light sources to cause an interference pattern to be formed, which is emitted by the sensor module 104. Similarly, if apparatus 100 comprises a single light source and a beam splitter, the actuation module(s) 114 may be used to move one or both of the light source and beam splitter to create an interference pattern. Interference of the light from the two sources/two beams/multiple beams/ may give rise to a pattern of regular, equidistant lines, which can be used for 3D sensing. Using the SMA-based actuation module(s) 114 to move the light sources (i.e. change their relative position and/or orientation) may produce an interference pattern having different sizes. This may enable the apparatus 100 to generate 3D representations of different types of scenes, e.g. 3D representations of a face which may be close to the apparatus 100, or 3D representations of a town/city having objects of different sizes and at different distances from the apparatus 100. In another example, apparatus 100 may project a light pattern, e.g. by passing light through a spatial light modulator, a transmissive liquid crystal, or through a patterned plate (e.g. a plate comprising a specific pattern of holes through which light may pass), a grid, grating or diffraction grating. In this example, the SMA-based actuation module(s) 114 may be arranged to move the light source and/or the components (e.g. grating) used to create the light pattern.

In embodiments where the emitter of sensor module 104 is or comprises a source of electromagnetic radiation, the actuation module(s) 114 may be configured to control the position and/or orientation of the source and/or at least one optical component in order to control the position of the radiation on objects within the scene being imaged. In embodiments, the source of electromagnetic radiation may be a laser. The at least one optical component may be any of: a lens, a diffractive optical element, a filter, a prism, a mirror, a reflective optical element, a polarising optical element, a dielectric mirror, and a metallic mirror. The receiver may be one of: a light sensor, a photodetector, a complementary metal-oxide-semiconductor (CMOS) image sensor, an active pixel sensor, and a charge-coupled device (CCD).

In embodiments, the emitter of sensor module 104 is or comprises a sound wave emitter for emitting a plurality of sound waves. For example, the sensor module 104 may emit ultrasound waves. The emitter of the sensor module 104 may be tuneable to emit sound waves of different frequencies. This may be useful if, for example, the apparatus 100 is used to generate 3D representations of scenes of differing distance from the apparatus 100 or where different levels of resolution are required in the 3D representation. The receiver of the sensor module 104 may comprise a sound sensor or microphone.

### Altering Position/Orientation to Generate a 3D Representation

FIG. 2 shows a flowchart of example steps for generating a three-dimensional representation of a scene using the apparatus 100 of FIG. 1. The process begins when apparatus 100 emits a plurality of waves (step S200) to collect data relating to a scene being imaged. The apparatus receives reflected waves, which may have been reflected by one or more objects in the scene being imaged (step S202). Depending on how far away the objects are relative to the emitter/apparatus 100, the reflected waves may arrive at different times, and this information may be used to generate a 3D representation of a scene.

The apparatus 100 may determine if the location and/or orientation of the apparatus 100 has changed relative to the scene (or objects in the scene) being imaged at step S 204. Alternatively, apparatus 100 may receive data from sensor(s) 128 indicating that the location and/or orientation of the apparatus 100 has changed (e.g. due to a user's hand shaking while holding apparatus 100). If the location and/or orientation of apparatus 100 has not changed, then the process continues to steps S210 or S212. At step S210 the apparatus may generate a 3D representation of a scene using the received reflected waves. For example, the apparatus may use time of flight methods or distortions in a projected pattern of radiation to determine the relative distance of different objects within a scene (relative to the apparatus 100) and use this to generate a 3D representation of the scene. Alternatively, as explained above, at step S212 the apparatus may transmit data to a remote device, server or service to enable a 3D representation to be generated elsewhere. The apparatus may transmit raw data or may process the received reflected waves and transmit the processed data.

If at step S204 it is determined that the apparatus's location and/or orientation has changed, then the process may comprise generating a control signal for adjusting the position and/or orientation of a moveable component of the apparatus to compensate for the change (step S206). The control signal may be sent to the relevant actuation module and used to adjust the position/orientation of the component (step S208). In embodiments, the actuation module may adjust the position/orientation of a lens, a diffractive optical element, a filter, a prism, a mirror, a reflective optical element, a polarising optical element, a dielectric mirror, a metallic mirror, a beam splitter, a grid, a patterned plate, a grating, or a diffraction grating. When the adjustment has been made, the process returns to step S200.

It will be understood that in embodiments where the emitter emits a pattern of structured electromagnetic radiation (e.g. a pattern of light), the process shown in FIG. 2 may begin by adjusting the position and/or orientation of one or more moveable components in order to create the pattern of structured radiation.

### Altering Position/Orientation for Super-Resolution

Super-resolution (SR) imaging is a class of techniques that may enhance the resolution of an imaging system. In some SR techniques—known as optical SR—the diffraction limit of a system may be transcended, while in other SR techniques—known as geometrical SR—the resolution of a digital imaging sensor may be enhanced.

Structured light is the process of projecting a known pattern (e.g. a grid or horizontal bars) onto a scene. The way that the pattern deforms when striking a surface allows imaging systems to calculate the depth and surface (shape) information of objects in the scene. An example structured light system uses an infrared projector and camera, and generates a speckled pattern of light that is projected onto a scene. A 3D image is formed by decoding the pattern of light received by the camera (detector), i.e. by searching for the emitted pattern of light in the received pattern of light. A limit of such a structured light imaging system may be the number of points or dots which can be generated by the emitter. It may be difficult to package many hundreds of light sources close together in the same apparatus and therefore, beam-splitting diffractive optical elements may be used to multiply the effective number of light sources. For example, if there are 300 light sources in an apparatus, a 10×10 beam splitter may be used to project 30,000 dots onto a scene (object field).

However, there is no mechanism for absolutely decoding the pattern of light received by the camera. That is, there is no mechanism for identifying exactly which dots in the received pattern of light (received image) correspond to which dots in the emitted pattern of light. This means it may be advantageous to make the dot patterns sparse, because the denser the dot pattern, the more difficult it becomes to accurately map the received dots to the emitted dots. However, limiting the number of dots in the emitted pattern limits the resolution of the output feedback. For example, U.S. Pat. No. 8,493,496 states that for good performance in the mapping process, it is advantageous that the spot pattern have a low duty cycle, i.e. that the fraction of the area of the pattern with above-average brightness be no greater than 1/e (˜37%). In other words, 1/e may represent an upper limit on practical fill factors for this type of structured light pattern.

FIG. 3 is a schematic diagram of an apparatus 302 that is or comprises a structured light system used for depth mapping a target/object/scene 300. The apparatus 302 may be a dedicated structured light system, or may comprise a structured light system/ 3D sensing system. For example, the apparatus 302 may be a consumer electronics device (such as, but not limited to, a smartphone) that comprises a 3D sensing system. A depth-sensing device 302 may comprise an emitter 304 and a detector 306 which are separated by a baseline distance b. The baseline distance b is the physical distance between the optical centres of the emitter 304 and detector 306. The emitter 304 may be arranged to emit radiation, such as structured radiation, on to the target 300. The structured radiation may be a light pattern of the type shown in FIG. 4. The light pattern emitted by emitter 304 may be transmitted to the target 300 and may extend across an area of the target 300. The target 300 may have varying depths or contours. For example, the target 300 may be a human face and the apparatus 302 may be used for facial recognition.

The detector 306 may be arranged to detect the radiation reflected from the target 300. When a light pattern is emitted, the detector 306 may be used to determine distortion of the emitted light pattern so that a depth map of the target 300 may be generated. Apparatus 302 may comprise some or all of the features of apparatus 100—such features are omitted from FIG. 3 for the sake of simplicity. Thus, apparatus 302 in FIG. 3 may be considered to be the same as apparatus 100 in FIG. 1, and may have the same functionalities and may be able to communicate with other devices, servers and services as described above for FIG. 1.

If it is assumed that the emitter 304 and detector 306 have optical paths which allow them to be modelled as simple lenses, the emitter 304 is centred on the origin and has a focal length off, the emitter 304 and detector 306 are aligned along the X axis and are separated by a baseline b, and the target 300 is primarily displaced in the Z direction, then a dot will hit the target 300 at a spot in 3D space, [Oₓ O_{y} O_{z}]. In the image space, the dot is imaged at

$$[ \frac{f ( {O}_{x} - b )}{{O}_{Z}} \frac{f \cdot {O}_{y}}{{O}_{Z}} ] .$$

By comparing the received dots with the projected dots (effectively a scaled pattern with no b term for the baseline or Oz term for depth), the depth of the target 300 may be deduced. (The y term gives absolute scale information, whilst the x term conveys parallax information with depth).

A structured light emitter and detector system (such as system/device 302 in FIG. 3) may be used to sample depth at discrete locations on the surface of object 300. It has been shown that, given certain assumptions, fields can be reconstructed based on the average sampling over that field. A field can be uniquely reconstructed if the average sampling rate is at least the Nyquist frequency of the band-limited input and the source field belongs to the L² space. However, the fidelity of this reconstruction relies on sampling noise being insignificant.

Sampling noise might arise directly in the measurement or due to bandwidth limitation of the data collection system.

As mentioned above, the position/orientation of a pattern of light (e.g. a dot pattern) may be deliberately shifted via an actuator (e.g. actuation module 114) in order to fill in the ‘gaps’ in the sampling map and provide super-resolution. Systems in which the projected pattern is moved during exposure have been proposed, but they suffer several issues. For example, such systems must still obey limits on fill factor in order to accurately recognise/identify features in the object/scene being imaged because, as explained above, the higher the density of dots the more difficult it becomes to map the received dots to the projected/emitted dots. Furthermore, such systems may have a reduced ability to accurately determine surface gradient because dot distortion may occur while the pattern is being moved, and the distortions that occur from the moving pattern may be indistinguishable for the distortion that occur when a dot hits a curved surface. These issues suggest that discrete exposures may be preferable.

Super-resolution functionality may rely on the assumption that the target (object being imaged) is relatively still. However, many camera users will have experienced ‘ghosting’ from High Dynamic Range (HDR) photos taken using smartphone cameras. Ghosting is a multiple exposure anomaly that occurs when multiple images are taken of the same scene and merged, but anything that is not static in the images result in a ghost effect in the merged image. Consumer products that use two exposures are common, and there are specialised consumer products which take up to four exposures, but more than that is unusual. There is no reason to presume that depth data should be particularly more stable than image data, and so two or four exposures may be desirable for synthesis such that frame rate may be maximised while disparity between measurements may be reduced.

An actuator or actuation module 114 may be used to move a pattern of light (e.g. structured light pattern). Image data collected while the actuation module 114 is moving a moveable component 116 either may not be processed, or may be processed subject to the issues described above which arise when a pattern is moved during exposure. An example image capture technique may comprise configuring the image sensor or detector to stream frames in a ‘take one, drop two’ sequence. That is, one frame may be kept and the subsequent two frames may be discarded, and then the next frame may be kept, and so on. The dropped frames provide a window of time during which the actuation module 114 may complete its movement to move the moveable component 116 to the next position. Depth sensors typically have relatively low pixel counts, so potentially very high frame rates could be realised (e.g. 120 frames per second (fps) or higher). A frame rate of 30 fps may be more typical, but this slower rate may increase the likelihood that both the emitter and the target move during the image capture process. In the example where an image capture device is capturing 120 fps, the ‘take one, drop two’ concept may provide a window of 8 ms in which the actuation module 114 may complete the movement of the moveable component 116.

Standard multiframe techniques may be used to merge captured image data together. However, due to data sparsity, the merging of captured image data may need to be done using inference rather than direct analytical techniques. The most common multiframe technique is frame registration. For example, an affine transformation may be used to deduce the best way to map frames onto each other. This may involve selecting one frame of data as a ‘key frame’ and then aligning other frames to it. This technique may work reasonably well with images because of the high amount of data content. However, depth maps are necessarily data sparse, and therefore Bayesian estimation of relative rotations and translations of the frames may be used instead to map the frames onto each other. In many instances, there will be insufficient evidence to disrupt a prior estimate of position, but where there is sufficient evidence this may need to be taken into account when merging images/frames.

For the reasons explained above, the actuation module 114 may be used to move/translate a structured light pattern to cover the ‘gaps’. However, the analysis of non-uniformly sampled data is relatively difficult and there is no single answer to guide where to place ‘new samples’ to improve the overall sampling quality. In a two-dimensional space, choosing to reduce some metric such as the mean path between samples or median path between samples may be a good indicator of how well-sampled the data is.

The above-mentioned example structured light system, comprising a light source (e.g. a laser beam, or a vertical-cavity surface-emitting laser (VCSEL) array) and a diffractive optical element (e.g. a beam splitter) provides relatively few opportunities to choose where new samples may be placed to improve the overall sampling quality. For example, the VCSEL array could be moved, or the diffractive optical element could be tilted—both options have the effect of translating the dot pattern, provided the movement can be effected without moving the VCSEL out of the focal plane of the optics, or without compromising any heatsink which may be provided in the system. Moving the VCSEL array may be preferred because, while tilting the diffractive optical element may have minimal impact on the zeroth mode (i.e. VCSEL emission straight through the diffractive optical element), such that the centre of the image will not be subject to significant motion, it is possible that better resolving the centre of the image is important.

FIG. 4 shows an exemplary pattern of light that may be used for 3D sensing. The pattern of light may be provided by a VCSEL array. To extract information from the movement of the pattern, processor 102 needs to know how much the actuation module 114 (and therefore of the moveable component 116) has moved during each sampled timestep. Due to the typical pseudo-random nature of the dot patterns used, there are typically no particularly good or bad directions in which to move the projected pattern—the improvement in sampling behaviour is quite uniformly good once the movement increases to about half of the mean inter-dot distance. However, for well-designed patterns of light, there may be a genuine optimal space beyond which the expected improvement falls

FIG. 5 is a flowchart of example steps for generating a 3D representation of a scene using the apparatus 100 of FIG. 1. The process begins when apparatus 100 emits a structured light pattern, such as a dot pattern (step S1000) to collect data relating to a scene being imaged. The emitter may continuously emit the light pattern, such that the light pattern is projected onto the scene while one or more components of the apparatus are being moved to shift the light pattern over the scene. In embodiments, the light pattern may be emitted non-continuously, e.g. only when the component(s) has reached the required position. The apparatus receives a reflected dot pattern, which may have been reflected by one or more objects in the scene being imaged (step S1002). If the scene or object being imaged has depth (i.e. is not entirely flat), the reflected dot pattern may be distorted relative to the emitted dot pattern, and this distortion may be used to generate a 3D representation (depth map) of the object.

As explained above, multiple exposures may be used to generate the 3D representation/depth map. Thus, at step S1004, the apparatus 100 may generate a control signal for adjusting the position and/or orientation of a moveable component of the apparatus to move the moveable component to another position for another exposure to be made. The control signal may be sent to the relevant actuation module 114 and used to adjust the position/orientation of the moveable component. The actuation module 114 may be used to move a moveable component by approximately half the mean dot spacing during each movement. The actuation module 114 may adjust the position/orientation of a lens, a diffractive optical element, a structured light pattern, a component used to emit a structured light pattern, a filter, a prism, a mirror, a reflective optical element, a polarising optical element, a dielectric mirror, a metallic mirror, a beam splitter, a grid, a patterned plate, a grating, or a diffraction grating. A reflected dot pattern may then be received (step S1006)—this additional exposure may be combined with the first exposure to generate the 3D representation. As explained earlier, while the actuation module 114 is moving the moveable component from the initial position to a subsequent position (which may be a predetermined/ predefined position or set of coordinates), the emitter may be continuously emitting a light pattern and the receiver/image sensor may be continuously collecting images or frames. Thus, processor 102 (or another component of apparatus 100) may discard one or more frames (e.g. two frames) collected by the receiver/image sensor during the movement. In this case therefore, the emitter continuously emits a pattern of light, and the receiver continuously detects received patterns of light. Additionally or alternatively, it may be possible to switch-off the receiver/image sensor and/or the emitter while the moveable component is being moved, such that either the emitter only emits when in the required position or that the receiver only detects reflected light when in the required position, or both.

The actuation module 114 may be configured to move the moveable component 116 to certain predefined positions/coordinates in a particular sequence in order to achieve super-resolution and generate a depth map of an object. The predefined positions/coordinates may be determined during a factory calibration or testing process and may be provided to the apparatus (e.g. to processor 102 or stored in storage 106 or memory 108) during a manufacturing process. The number of exposures, the positions at which is exposure is made, and the sequence of positions, may therefore be stored in the actuation module 114 for use whenever super-resolution is to be performed.

At step S1008, the process may comprise determining if all the (pre-defined) required number of exposures have been obtained/captured in order to generate the 3D representation. This may involve comparing the number of captured exposures with the number of pre-defined required number of exposures (which may be stored in storage 106/ memory 108). If the comparison indicates that the required number of exposures has not been achieved, the actuation module 114 moves the moveable component 116 to the next position in the pre-defined sequence to capture another image. This process may continue until all required exposures have been captured. In embodiments, step S1008 may be omitted and the process may simply involve sequentially moving the moveable component 116 to each pre-defined position and receiving a reflected dot pattern at that position. The number of exposures/images captured may be four exposures. In embodiments, the number of exposures may be greater than four, but the time required to capture more than four exposures may negatively impact user experience.

Once all the required exposures/images have been captured, the apparatus 100 may generate a 3D representation of a scene using the received reflected dot patterns. For example, the apparatus combines the exposures (potentially using some statistical technique(s) to combine the data) to generate a 3D representation of the scene (step S1010). Alternatively, as explained above, at step S1012 the apparatus may transmit data to a remote device, server or service to enable a 3D representation to be generated elsewhere. The apparatus may transmit raw data or may process the received reflected dot patterns and transmit the processed data.

Generally, in order for a depth sensor, such as a structured light depth sensor, to correctly calculate the depth, the angle of emission of the projected dots in the plane containing both the optical axis of the detector (e.g. a camera) and the emitter must be accurately known. This angle is hereinafter sometimes referred to as the primary angle. Errors in the primary angle will cause the depth calculation to infer that the observed object is closer or further from the detector than is actually the case. When an elements of the apparatus are movable relative to each other, (e.g. when an actuator is used to move the position of the dots in a structured light arrangement) as described above, this movement (and/or the operation of the actuator) may result in additional errors to this angle.

In general terms, arrangements of the present techniques seek to solve this issue by one or more of the following approaches: controlling the position of the movable element(s) of the apparatus more accurately, calibrating the position of the movable element(s) of the apparatus more accurately, or correcting for errors in that position, for example on an exposure-by-exposure basis.

A schematic illustration of the apparatus is shown in FIG. 6 which shows a structured light arrangement. The emitter apparatus includes an emitter 304 and a movable element 116, which in this case is a lens. The emitter 304 emits a plurality of waves (in this case beams of light) 501 which are incident on object(s) 300 in the scene being sensed. The beams 501 form a pattern of dots 310. The beams are generally emitted along a primary axis P of the emitter (although, as shown, the beams may diverge from running along or parallel to that axis).

When the beams 501 are incident on the object 300, they reflect, forming reflected waves 502 which are sensed by a detector 306 which is offset from the emitter 304.

Movement of the movable element 116 results in a change in location of the emitted predefined pattern on the object 300 and therefore reflection from different points on the object, thus improving the resolution as described above. However, errors or variability in the position and/or orientation of the movable element 116 can lead to errors in the relationship between the dots, particularly if the angle between the beams 501 and the principal axis is changed in an unknown (or unexpected) manner. The arrangements set out below seek to reduce, prevent and/or compensate for such errors or variability.

In a first arrangement, a bearing 315 is used to constrain the motion of the movable element(s).

In a first arrangement, the bearing 315 may be used to constrain the motion of the movable element(s) so that they only move in directions which are perpendicular to the plane containing e.g. the primary axis of the detector 305 and a line linking the emitter 304 and the detector 305 (in other words the plane of the view in FIG. 6). In other words, the bearing 315 is used to constrain the motion to a single axis (parallel to the X-axis in the drawing) which does cause the primary angle of the emission of the projected dots to change. This can reduce or prevent movement of the movable element 116 which cause the greatest random error in the position of the pattern as the movable element is moved.

FIG. 7 shows an example of an SMA actuator 701 including a bearing 710 which is configured to be used in such an arrangement. The bearing 710 is preferably a high tolerance bearing and errors in the orientation of the bearing could be tested and accounted for or removed in a factory calibration process.

The SMA actuator 701 comprises a support plate 702 which forms a support structure and a movable plate 703 that forms a movable element. The support plate 702 and the movable plate 703 are flat parallel sheets that face each other. A suspension system, that is described in more detail below, supports the movable plate 703 on the support plate 702 and guides movement of the movable plate 703 with respect to the support plate 702 along the X axis which is the movement axis in this example.

Two lengths of SMA wire 704 are arranged as follows to drive movement of the movable plate 703 with respect to the support plate 702 along the movement axis. The lengths of SMA wire 704 are separate pieces of SMA wire, each connected at one end to the support plate 702 by first crimp portions 705 and at the other end to the movable plate 703 by second crimp portions 706. The first and second crimp portions 705 and 706 crimp the lengths of SMA wire 704 to provide both mechanical and electrical connection. In this example, the lengths of SMA wire 704 are arranged in an aperture 707 in the movable plate 703 in order to minimise the thickness of the SMA actuation apparatus.

The two lengths of SMA wire 704 are inclined at a first acute angle θ with respect to a plane normal to the X axis. The first acute angle θ is greater than 0 degrees so that it applies a component of force to the support plate 702 and the movable plate 703 along the Z axis, and so can drive movement along the X axis. However, inclination of the SMA wires 704 at the first acute angle θ provides gain as the SMA wires 704 rotate when they contract to drive the relative movement, thereby causing the amount of relative movement along the X axis to be higher than the change in length of the wire.

The choice of the first acute angle θ sets the gain, with lower values providing greater gain at the expense of actuation force. To first order the gain is given by 1/sin(θ). By way of example, in the arrangement shown in FIG. 7, the first acute angle θ is 10 degrees and so the gain is around 5.7.

The two SMA wires 704 are under tension and are opposed in the sense that they apply forces to the movable plate 703 with respective components parallel to the X axis that are in opposite directions. That is, as viewed in FIG. 7, the SMA wire 704 that is uppermost is connected to the movable plate 703 at its upper end and so applies a force on the movable plate 703 with a downwards component along the X axis, and the SMA wire 704 that is lowermost is connected to the movable plate 703 at its lower end and so applies a force on the movable plate 703 with an upwards component along the X axis. Thus, the SMA wires 704 drive movement of the movable plate 703 in opposite directions along the X axis.

In use, the lengths of SMA wire 704 drive movement of the movable plate 703 along the X axis on application of drive signals that cause heating and cooling of the lengths of SMA wire 704, with the lengths of SMA actuator wire 704 contracting on heating and expanding under an opposing force on cooling. The lengths of SMA wire 704 are resistively heated by the drive signals and cool by thermal conduction to the surroundings when the power of the drive signals is reduced. The position of the movable plate 703 along the X axis is selected by differential control of the two SMA wires 704.

The suspension system comprises a pair of flexures 708 extending between the support plate 702 and the movable plate 703. In this example, the flexures 708 are formed integrally with the movable plate 703 and so are integrally connected thereto at one end. The flexures 708 are connected to the support plate 702 at the other end by a mechanical connection 709, such as welding, soldering or adhesive.

The flexures 708 are disposed outside the lengths of SMA wire 704 on opposite sides of the lengths of SMA wire 704 along the X (movement) axis. The flexures 708 extend along the Y axis, that is perpendicular to the X axis which is the movement axis and perpendicular to the Z axis which is the direction of the couple created by the lengths of the SMA wire 704. Thus, the flexures 708 guide movement along the X axis by bending of the flexures in the X-Y plane. The flexures 708 provide this function with a construction that is relatively compact.

Furthermore, due to the stiffness of the material along their length, the flexures 708 generate forces along their length which generate a reactive couple that resists the resultant couple generated by the lengths of SMA wire 704.

It is desirable to minimise the forces generated along the lengths of the flexures 708 when the reactive couple is generated. This has the benefit of minimising the elastic constants of the flexures 708. This is facilitated by the flexures 708 being arranged outside the two lengths of SMA wire 704 on opposite sides of the lengths of SMA wire 704 along the X axis. In general, this makes it desirable to increase the separation between the flexures 708.

Although the use of the flexures 708 is advantageous in being compact and convenient to manufacture, as an alternative the flexures 708 could be replaced by respective bearings of any other form.

In addition to the flexures 708, the suspension system comprises a bearing arrangement of two bearings 710 which are arranged as follows to permit movement of the movable plate 703 with respect to the support plate 702 along the X axis, while constraining other undesired movements that are not constrained by the flexures 708. The bearings 710 may be rolling bearings or plain bearing elements, as described in more detail below. Each of the two bearings 710 may extend along the X axis so as to permit movement of the movable plate 703 with respect to the support plate 702 along the X axis. There may be more than 2 bearings, and preferably they are space apart as far as possible within the extent of the actuator.

The bearings 710 are arranged between the support plate 702 and the movable plate 703 which is convenient due to their nature as planar sheets extending parallel to the X axis which is the movement axis. Accordingly, the bearings 710 constrain translational movement of the movable plate 703 with respect to the support plate 702 along the Z axis, that is parallel to the resultant couple generated by the lengths of SMA wire 704.

As described in more detail below, the bearings 710 have a linear extent along the X axis so that the reactive forces within each bearing 710 constrain rotational movement of the movable plate 703 with respect to the support plate 703 about the Y axis which is perpendicular to the X axis which is the movement axis and is perpendicular to the couple generated by the lengths of SMA wire 704 along the Z axis.

The two bearings 710 are spaced apart along the Y axis, in this example being arranged outside the lengths of SMA wire 704 on opposite sides of the lengths of SMA wire 704 along the Y axis. As a result, the reactive forces generated within the bearings 710 act together to constrain rotational movement of the movable plate 703 with respect to the support plate 702 about the X axis which is the movement axis.

The bearing 710 may be a rolling bearing. In this case, the bearing 710 comprises bearing surfaces (not shown) formed on the support plate 702 and the moveable plate 703 and plural rolling bearing elements (not shown) disposed between the bearing surfaces. The rolling bearing elements may be balls and may be made of metal. The bearing surfaces may similarly be made of metal.

In a second arrangement, a mechanical element 150 is used to constrain the motion of the movable element 116 by limiting the extent of its motion in at least one direction. The mechanical element preferably forms part of, or is attached to, the static part of the apparatus.

FIG. 8 shows an example of such a mechanical element 150 and its inter-relation with the movable element 116 in four different configurations. The mechanical element 150 has a plurality of reference surfaces 151 which, in the arrangement shown in FIG. 8 are four right-angled sections arranged at the corners of a square. The movable element 116 is able to move in the plane of the square formed by the reference surfaces (and may be constrained by a further mechanical element, such as a bearing, to only move in that plane).

An actuator mechanism 114 is arranged to drive the movement of the movable element 116. The actuator mechanism may include a plurality of actuators arranged to drive the movable element in a plurality of directions. For example the actuators may be arranged to drive the movable element in orthogonal directions and/or pairs of actuators may be arranged to drive the movable element in opposed directions. The actuation may be as described in the applicant's co-pending application PCT/GB 2019/050965 and/or in WO 2019/086855 A1.

The mechanical element 150 and actuators are arranged such that, at the extremes of motion towards the corners of the square defined by the mechanical element 150, the movable element 116 contacts the reference surfaces 151 before reaching the maximum extent of motion permitted by the actuators. This causes the edge and/or sides(s) of the movable element 116, in the direction of movement, to contact the reference surface(s) 151 and the actuator to urge the movable element into firm contact with the reference surface(s). By arranging a plurality of such surfaces at different extremes of the motion of the movable element 116, the mechanical element 150 defines a plurality of reference positions of the movable element, for example as shown in the four different arrangements in FIG. 8.

As these reference positions are fixed relative to the static elements of the device, the position of the movable element 116 in each of the reference positions is both well-known and predictable. This means that the pattern produced by the emitter 304 can be calibrated in the factory after manufacture and the pattern and/or related parameters stored in the device (for example in a memory device).

Moreover, as the reference positions are constraints on the extremes of movement of the movable element 116, it is not necessary for the actuator mechanism to use, for example, a resistance feedback control technique such as described in WO 2014/076463 A1, and/or to exercise detailed control over the motion of the movable element 116. For example, the actuator mechanism may use a mechanism to drive the movable element in the desired directions (rather than controlling the extent of this movement and, in particular, rather than using a feedback control technique, a proportional control technique, etc.) as the bearing will ensure that movable element only ends up in one of the reference positions.

It will be appreciated that, whilst FIG. 8 shows a movable element 116 which has a square cross-section in the plane of motion, and a mechanical element 150 which defines the plurality of reference positions as the corners of a square, other configurations of the movable element 116 and/or mechanical element 150 are possible which utilise the same principle.

For example, the movable element 116 may have a cross-section of a different regular polygon (e.g. a hexagon) and the mechanical element 150 may be arranged to provide a number of reference positions each of which corresponds to one of the vertices of the polygon.

In some arrangements the mechanical element 150 may consist of a pair of opposed reference surfaces which are parallel to each other with the movable element 116 disposed between them. The actuator mechanism is arranged to drive the movable element 116 perpendicular to the reference surfaces so that the reference surfaces act as “end stops” constraining the motion of the movable element 116 at either end of its motion. In particular arrangements, the direction perpendicular to the reference surfaces may be the X axis as shown in the arrangement of FIG. 6, so as to address errors in the primary angle.

In some arrangements the movable element 116 may be arranged to rotate about one or more axes and the mechanical element 150 may then provide a plurality of “end stops” which constrain the extent of that rotation at a certain extent of rotation about one of said axes and, in certain arrangements, at a plurality of extents of rotation, for example at at least two opposed extents which are in opposite senses of rotation about a particular axis.

Alternatively or additionally, the movable element 116 and/or the mechanical element 150 may be arranged so that when the movable element is urged into contact with the mechanical element proximate to one or more of the reference positions, the interaction between the movable element 116 and the reference surface(s) 151 causes the movable element to rotate about an axis perpendicular to the plane of motion of the movable element. This may be achieved by having the reference surface(s) 151 arranged so that they are not perpendicular to the direction of motion caused by the actuator.

Alternatively or additionally, the mechanical element 150 may have a structure which defines the plurality of reference positions in three-dimensional space, and the movable element may be able to move in, and be driven in, three-dimensions so as to engage with the reference surfaces 151 at the plurality of reference positions.

The actuator mechanism and/or the movable element 116 may have one or more biasing elements which cause the movable element to adopt a rest position. This rest position may be one of the reference positions defined by the mechanical element 150, or a neutral position which is none of the reference positions.

In an alternative configuration, which is shown schematically in FIG. 9, the mechanical element may provide a single reference surface 152, such as a flat planar surface. The actuator mechanism may then be configured to move the movable element 116 between a plurality of predetermined reference positions 160a-160c, each of which is on the reference surface 152. When the movable element is moved to one of those reference positions, the actuator mechanism is arranged to drive the movable element into firm contact with the reference surface (in the direction shown by the arrow U in FIG. 9) such that the orientation and/or position in one direction of the movable element is defined by the reference surface alone.

By appropriate arrangement of the reference surface 152, this arrangement can ensure that the orientation of the movable element 116 is always consistent about at least one axis, preferably two orthogonal axes (being axes lying in a plane parallel to the reference surface 152), and therefore, in particular, that the angle of emission of the projected pattern in e.g. the plane containing the primary axis P of the emitter is fixed by the reference surface 152 when the movable element 116 is in each of the reference positions 160a-160c.

If the reference surface 152 can be accurately defined and positioned, this may be sufficient to remove or reduce errors caused by changes in the orientation of the movable element 116. Alternatively or additionally, the device may undergo factory calibration with the movable element arranged in each of the plurality of reference positions so that the errors in the emitted pattern resulting from the orientation of the movable element can be determined and the device calibrated to take account of those errors.

This may be achieved using an arrangement as described in the applicant's co-pending application GB1820383.6, which is incorporated herein by this reference.

The projected arrangements of the predetermined pattern may be emitted when the movable element 116 is in positions which are not the reference positions, for example intermediate position 160 d shown in FIG. 9. In such an arrangement the position and/or orientation of the movable element is not well-known, but can be inferred or interpolated from the nearby reference positions, for example as described further below.

The reflected waves from the objects in the scene which are being sensed are processed by a processor 102 as described above. In a further arrangement, as well as the normal processing of these reflected waves, for example to determine a depth map, the processor 102 may correct for errors and/or variations in the reflected waves caused by variations or unknown variables in the positioning of the movable element. The processing to correct for the errors or variations may of course be performed by a separate processor.

In one configuration, the processor 102 is arranged to compare the determined depth positions of objects in the scene which are obtained from two or more different positions of the movable element and to adjust or correct one or more of the determined depth positions based on that comparison.

The comparison may, for example, identify a systematic error in the depth positions determined from one arrangement of the movable element compared to the depth positions determined from another. The comparison may, alternatively or additionally, identify a random error arising the depth positions determined from one arrangement. The latter may be exemplified by the identification of an outlier depth position which is inconsistent with the depth positions previously calculated. Such an outlier may be a result of, for example, interference between waves in the emitted pattern or a portion part of the reflected waves being misinterpreted as being generated by a different portion of emitted pattern.

The processor 102 may use the depth positions determined when the movable element is in a known reference position as the baseline for its comparison. The depth positions determined when the movable element is in a known reference position are likely to be relatively error-free and therefore provide a good baseline for comparison.

The reference position may be one or more of the reference positions defined by the mechanical elements in the above-described arrangements of the apparatus. For example, if it is desirable to determine depth positions in arrangements where the movable element is not in one of the defined reference positions, the processor may be arranged to use the depth positions determined when the movable element is in one of the defined reference positions as the baseline for its comparison to determine the variations or errors in a depth position determined when the movable element is in a further position which is not one of the defined reference positions and potentially to correct for any errors or variations found. The reference position used for the baseline can be the reference position which is closest in space to the further position.

Typically the reflected waves received when the movable element is in different positions will not originate from the same portions of the objects in the scene and therefore a direct comparison cannot necessarily be made between the determined depth positions in the two arrangements.

Therefore the processor 102 may interpolate between determined depth positions in the arrangement which is being used as a baseline for the comparison in order to determine the expected depth position and any variation from that in the arrangement which is being compared. The processor 102 may be arranged to ignore variations compared so such interpolations which fall below a predetermined threshold as being acceptable and/or likely variations in depth. Any such threshold may be a variable threshold, for example by being dependent on the distance that the interpolated point is from a directly-determined depth position in the baseline positions.

The processor 102 may be arranged to take account of historically-determined depth positions. For example, the processor 102 may store the variations determined between two or more positions of the movable element in previous scenes and use these in the comparison. compare the determined depth positions with previously-recorded determined depth positions for the same scene.

The processor 102 may be arranged to construct a reference set of depth positions based on a plurality of previously-determined depth positions for the scene. This may take the form of an average (which may be a weighted average, for example to take account of how long ago the positions were determined) of the depth positions determined from previous positions of the movable element.

Alternatively or additionally, the processor 102 may be arranged to determine an average of all of the determined depth positions for a particular position of the movable element and compare that average to the average of all of the determined depth positions for the second or further position of the movable element. Whilst determining an average will inevitably remove precision from the determined depth positions, it may be useful in identifying systematic errors or variations (for example if the average depth determined in two arrangements which are closely-spaced in time is substantially different, this is likely to be the result of a systematic error which has caused all depth positions in one of the determinations to be determined as being closer to the apparatus or further away from the apparatus. Again, a threshold may be applied so as to avoid small variations, which may naturally arise as a result of the objects in the scene, or the apparatus itself, moving, being classified as errors.

In a further development, the processor 102 may be arranged to deliberately position the movable element in at least one pair of positions such that one portion of the emitted pattern in the first position directly overlaps with a different portion of the emitted pattern in the second position. For example, in a structured light arrangement, the processor may be arranged to deliberately project one dot in a second arrangement onto the same point (or, in wave-terms, along the same axis) as a dot in a first arrangement. Such an arrangement could clearly be repeated between additional pairs of positions and/or additional portions of the emitted pattern. It should be noted that such overlap between the pattern in different positions is generally considered undesirable as it can reduce the benefits of the super-resolution because the same portion(s) of the scene are being sampled and imaged.

However, when used in the present arrangement with the processor making a comparison between the determined depth positions, such an arrangement can be beneficial as any variation in the depth positions determined for the respectively overlapping portions of the pattern can be identified as an error, because it would be expected that the objects in the scene would reflect the emitted waves identically back to the apparatus in each of the arrangements. Again, such a determination may be subject to the application of a threshold to account for acceptable relatively movement of the apparatus and the object(s) in the time between the two arrangements. A variable threshold may be applied which takes account of the known time between the two arrangements.

Where references are made in this application to directions and/or planes and/or various components or surfaces being orthogonal or perpendicular, it will appreciated that this covers arrangements in which the directions, planes, components or surfaces are substantially arranged in an orthogonal or perpendicular relationship, even if not exactly so. In particular such description encompasses all arrangements in which the indicated effects of the relationship are obtained, even if the arrangements are not precisely as indicated.

When reference is made to above “variations” and/or “errors”, such as in the positioning of the movable element or the waves, this includes both systematic and random errors. The arrangements described above preferably reduce or substantially or completely eliminate at least the random errors resulting from the movement of the movable element. Systematic errors may also be reduced or eliminated by these approaches, but are generally of lesser importance as they can be more readily compensated for using other techniques and/or have a lower impact on the accuracy of the 3D sensing.

The techniques and apparatus described herein may be used for, among other things, facial recognition, augmented reality, 3D sensing, depth mapping. aerial surveying, terrestrial surveying, surveying in or from space, hydrographic surveying, underwater surveying, and/or LIDAR (a surveying method that measures distance to a target by illuminating the target with pulsed light (e.g. laser light) and measuring the reflected pulses with a sensor). It will be understood that this is a non-exhaustive list.

Except where the context requires otherwise, the term “bearing” is used herein as follows. The term “bearing” is used herein to encompass the terms “sliding bearing”, “plain bearing”, “rolling bearing”, “ball bearing”, “roller bearing” and “flexure”. The term “bearing” is used herein to generally mean any element or combination of elements that functions to constrain motion to only the desired motion and reduce friction between moving parts. The term “sliding bearing” is used to mean a bearing in which a bearing element slides on a bearing surface, and includes a “plain bearing”. The term “rolling bearing” is used to mean a bearing in which a rolling bearing element, for example a ball or roller, rolls on a bearing surface. In embodiments, the bearing may be provided on, or may comprise, non-linear bearing surfaces.

In some embodiments of the present techniques, more than one type of bearing element may be used in combination to provide the bearing functionality. Accordingly, the term “bearing” used herein includes any combination of, for example, plain bearings, ball bearings, roller bearings and flexures.

Although some of the above approaches have been described with specific reference to cameras and camera assemblies, it will be appreciated that the configuration and/or control of the actuator assemblies involved can be applied in other fields where control of an iris is desired.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A method for use in generating a three-dimensional representation of a scene, the method comprising:
emitting a plurality of emitted waves in a predetermined pattern, the pattern having a primary axis;
moving a movable portion relative to a static portion of an emitter module so as to emit said predetermined pattern in a plurality of different arrangements depending on the position and/or orientation of the movable portion;
wherein the movement of the movable portion is constrained by a mechanical element so as to provide a predictable orientation of the primary axis relative to the static portion in one or more of the different arrangements.

2. The method according to claim 1 wherein the moving comprises moving the movable portion to one or more positions and/or orientations relative to the static portion, each of those positions and/or orientations causing the emitter module to emit said predetermined pattern in a different one of said plurality of arrangements

3. The method according to claim 1 wherein the moving comprises urging the movable portion against the mechanical element in each of said one or more positions and/or orientations such that the position and/or orientation of the movable portion is predictable.

4. The method according to claim 1 wherein the mechanical element constrains movement of the movable portion in each of the one or more positions in two mutually orthogonal directions and/or about two mutually orthogonal axes.

5. The method according to claim 4 wherein the moving is performed by controlling the direction rather than the magnitude of displacement of the movable portion.

6. The method according to claim 1 comprising:
moving the movable portion to a first position and/or orientation in which a first arrangement of said predetermined pattern is emitted and a second position and/or orientation in which a second arrangement of said predetermined pattern is emitted, wherein the movable portion is constrained by the mechanical element in the first position and/or orientation and is unconstrained by the mechanical element in the second position and/or orientation; and the method comprises;
receiving, for each of the first and second arrangements of said predetermined pattern, a reflected wave arrangement including reflected waves which are reflections from one or more objects in the scene;
processing the reflected waves received at the receiver and correcting for the effects of variations in the reflected wave arrangements caused by errors in the positioning of the movable element in the second position and/or orientation based on the reflected waves received for the first position.

7. An Apparatus for use in a device for generating a three-dimensional representation of a scene, the apparatus comprising:
an emitter module having:
an emitter for emitting a plurality of emitted waves in a predetermined pattern, the pattern having a primary axis;
a static portion; and
a movable portion configured to allow the emitter module to emit said predetermined pattern in a plurality of different arrangements depending on the position and/or orientation of the movable portion relative to the static portion; and
a mechanical element to constrain the movement of the movable portion so as to provide a predictable orientation of the primary axis relative to the static portion in one or more of the different arrangements.

8. The apparatus according to claim 7 wherein the mechanical element is a bearing.

9. The apparatus according to claim 7 further comprising an actuator arranged to move the movable portion to one or more positions and/or orientations relative to the static portion, each of those positions and/or orientations causing the emitter module to emit said predetermined pattern in a different one of said plurality of arrangements.

10. The apparatus according to claim 9 wherein the mechanical element is fixed relative to the static portion and the actuator is arranged to urge the movable portion against the mechanical element in each of said one or more positions and/or orientations such that the position and/or orientation of the movable portion is predictable.

11. The apparatus according to claim 10 wherein actuator primarily provides control of the direction rather than the magnitude of displacement of the movable portion.

12. The apparatus according to claim 10 wherein the mechanical element constrains movement of the movable portion in each of the one or more positions in two mutually orthogonal directions and/or about two mutually orthogonal axes.

13. The apparatus according to claim 10 wherein the mechanical element is configured to urge an optical element into a predetermined orientation in each of the plurality of positions.

14. The apparatus according to claim 10 wherein, in each of said one or more positions of the moveable portion, the mechanical element constrains movement of the movable portion in a single direction and wherein the actuator is arranged to move the movable portion to a plurality of positions in a plane perpendicular to said single direction.

15. The apparatus according to claim 7 wherein the mechanical element is configured to provide a predictable orientation of the primary axis when projected onto a plane defined relative to the static portion.

16-17. (canceled)

18. An apparatus for generating a three-dimensional representation of a scene, the apparatus comprising:
an emitter module for emitting a plurality of emitted waves in a predetermined pattern;
a movable portion configured to allow the emitter module to emit said predetermined pattern in a plurality of different arrangements depending on the position and/or orientation of the movable portion;
a receiver for receiving a plurality of reflected wave arrangements for each of the different arrangements of the predetermined pattern, the reflected wave arrangements including reflected waves which are reflections from one or more objects in the scene, and
a processor for processing the reflected waves received at the receiver which is configured to correct for the effects of variations in the reflected wave arrangements caused by errors in the positioning of the movable portion based on a relationship between the reflected waves received in two or more of the plurality of reflected wave arrangements.

19. The apparatus according to claim 18 wherein the processor is arranged to determine positional information about said objects in the scene from the reflected waves.

20. The apparatus according to claim 19 wherein the processor is arranged to correct for the effects of variations by comparing the positional information determined from one reflected wave arrangement with an interpolation of the positional information determined from one or more other reflected wave arrangements.

21. The apparatus according to claim 19 wherein the processor is arranged to correct for the effects of variations by using historic information, wherein the historic information includes information about the effects of variations from a previous reflected wave arrangement obtained when the movable portion was in the same position.

22. (canceled)

23. The apparatus according to claim 19 wherein the processor is arranged to correct for the effects of variations by comparing the positional information determined from one reflected wave arrangement to an average of the positional information obtained from all reflected waves in the reflected wave arrangement.

24. The apparatus according to claim 19 wherein the apparatus further includes an actuator arranged to move the movable portion to one or more positions and/or orientations relative to a static portion, each of those positions and/or orientations causing the emitter module to emit said predetermined pattern in a different one of said plurality of arrangements.

25. The apparatus according to claim 24 further including a controller which controls the actuator, wherein the controller is configured to control the actuator to position the movable portion in a first position and/or orientation in which a first arrangement of said predetermined pattern is emitted and a second position and/or orientation in which a second arrangement of said predetermined pattern is emitted, wherein the controller is configured to control the actuator such that two different portions of the predetermined pattern are coincident in the first and second arrangements so as to enable the said correction.

26. (canceled)

27. The apparatus according to claim 25, further comprising:
a mechanical element to constrain the movement of the movable portion so as to provide a predictable orientation of a primary axis of the pattern relative to the static portion in one or more of the different arrangements;
wherein the movable portion is constrained by the mechanical element in the first position and/or orientation and is unconstrained by the mechanical element in the second position and/or orientation
wherein the processor is configured to correct for the effects of variations in the reflected wave arrangements caused by errors in the positioning of the movable element in the second position and/or orientation based on the reflected waves received for the first position.

28-29. (canceled)
